(19) United States
(12) Patent Application Publication
(10) Pub. No.: US 2002/0063089 A1
(43) Pub. Date: May 30, 2002

(54) Water filtration device employing far infrared media

(76) Inventor: John H. Douglas, Clearwater, FL (US)

Correspondence Address: Joseph A. Mahoney, Mayer, Brown & Platt, P.O. Box 2828, Chicago, IL, 60690-2828, US

(21) Appl. No.: 09/766,031

(22) Filed: Jan. 19, 2001

Related U.S. Application Data
(63) Continuation-in-part of application No. 09/736,637, filed on Dec. 14, 2000.
Application No. 09/736,637 is a continuation-in-part of application No. 09/431,942, filed on Oct. 1, 1999, now abandoned.
(60) Provisional application No. 60/249,033, filed on Nov. 15, 2000.

(51) Int. Cl. B01D 24/00

(52) U.S. Cl. 210/266

(57) ABSTRACT

An improved filter device for the removal of contaminants from water and method of using same. The filter device of the present invention comprises a housing and far-infrared filtration media.

### FIELD OF THE INVENTION

The present invention relates to fluid treatment. In particular, the present invention relates to water filtration devices.

### BACKGROUND OF THE INVENTION

Tap water contains many contaminants. If not removed from the water, these contaminants may present health risks, may damage plumbing and personal property, and may adversely affect the taste of the water. The principal contaminants naturally occurring in water are iron, sulfur, and manganese. Many man-made contaminants are also now found in tap water. These man-made contaminants, generically defined as halogenated organics, may be introduced into the water supply as part of or as by-products of herbicides, pesticides, fertilizers and the like placed on and into the ground. These halogenated organics are believed to be carcinogenic and may present serious long term health risks to users of this contaminated water.

Traditionally, the properties of water have been evaluated from the standpoint of pH (whether the water is acidic or alkaline). Recently, experts claim that reduction-oxidation (“redox”) potential is more important than the pH of the water. For example, the pH of tap water is about 7.0, which is neutral. When tap water is electrolyzed, it has a pH of about 9 and the oxidized water has a pH of about 4. Even if you make alkaline water of pH 9 by adding sodium hydroxide, or makes acidic water of pH 3 by adding hydrogen chloride, very little change will be found in redox potential in these two fluids. In contrast, when you divide tap water with electrolysis you can see the redox potential fluctuate by as much as +/− 1,000 mV. By electrolysis, reduced water may be obtained with a negative potential that is beneficial to the body and oxidized water may be obtained with a positive potential having bactericidal properties. For example, oxidized water with a redox potential of +1100 mV is an oxidizing agent that can withdraw electrons from bacteria and kill them. Therefore, oxidized water can be used to clean hands, kitchen utensils, fresh vegetables and fruits, etc. Tests have shown that this super oxide water can destroy MRSA (Methicillin Resistant Staphylococcus Aureus) very quickly. Although super oxide water is a powerful sterilizing agent, it will not harm the skin; and in fact, super oxide water is effective in the treatment of bedsores. See Lotts “Where Oxidation Reduction Media Work”, incorporated herein by reference, regarding the uses of redox reactions.

The KDF filter media is a copper-zinc reduction/oxidation media that has been shown by testing to reduce chlorine, as well as other contaminants in tap water. KDF filter media removes or reduces chlorine and contaminants from water because of the electrical and catalytic potential of the redox alloy. Testing, however, revealed that the KDF type 55 did not remove chlorine from the tap water at a city water source that was treated with aluminum sulfate. Further, investigation revealed that the aluminum sulfate treated water has a deleterious effect on the action of the KDF filter in reducing chlorine.

Therefore, there is a need for a water filter containing an effective media with increased redox potential to reduce the amount of contaminates in water.

### SUMMARY OF THE INVENTION

The present invention relates to an improved filter device for the removal of contaminants from water comprising a filter housing having an inlet at one end and an outlet at an opposing end thereof. Within the filter housing is at least one region of a far infrared media.

### BRIEF DESCRIPTION OF THE DRAWINGS

FIG. 1 is a cross-sectional view illustrating a simple embodiment of the present invention.

FIG. 2 is a cross-sectional view illustrating the relationship of the components in another embodiment of the present invention.

FIG. 3 is a cross-sectional view illustrating the relationship of the components in yet another embodiment of the present invention.

### DETAILED DESCRIPTION

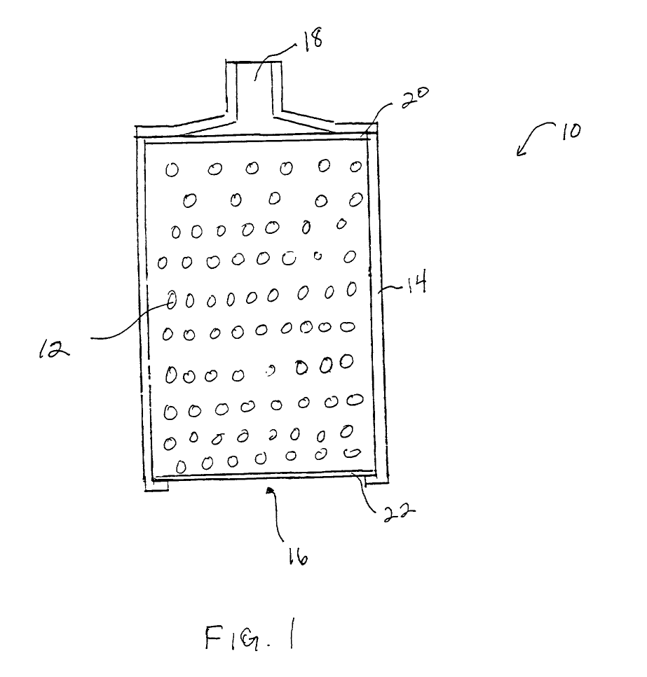

As depicted in FIG. 1, the present invention relates to a filter 10 having a far infrared media 12 located therein. Far infrared media 12 emits far infrared radiation of the wavelength of about 5-1,000 microns. Far infrared media 12 is obtained by methods known in the art such as by pulverizing natural stone, which has been absorbing solar energy for a geologically long time period. The far infrared media 12 of the present invention comprises at least about 20% of silica (Si), about 15% of aluminum (Al), about 10% of potassium (K) and about 5% of iron (Fe). These materials may be formed into spheres or other geometric shapes and may have a diameter varying between about 0.01 to 2.0 inches. Such far infrared media 12 can be obtained commercially from 21st Century Innovative Products (Chicago, Ill.).

Although not to be bound to any one theory, the Applicant believes that the far infrared media 12 electrolyzes the supplied water to create redox potential to generate a purified and bactericidal product. Further, it is believed that the far infrared media 12 removes radon from the supplied water, further purifying the water.

The filter 10 comprises a housing 14 having an inlet 16 and an outlet 18 to allow water to flow through the housing and an outlet screen 20 impeding the far infrared media 14 and other media, if applicable, from travelling through the outlet 18. In another embodiment, an inlet screen 22 impedes the movement of far infrared media 14 and other media, if applicable, through the inlet 16. The housing 14 is preferably constructed or injection molded of acrylonitrile-butadiene-styrene (ABS). Those skilled in the art, however, will appreciate that any suitable temperature resistant thermoplastic material or other suitable material may be utilized for the housing 14. The outlet screen 20 and the inlet screen 22 may be constructed from stainless steel or any other suitable material and may have a mesh value in a range of about 50 to about 100 microns. As is known by those skilled in the art, other types of non-reactive screens/filters may be used in lieu of the steel outlet screen 20 and input screen 22.

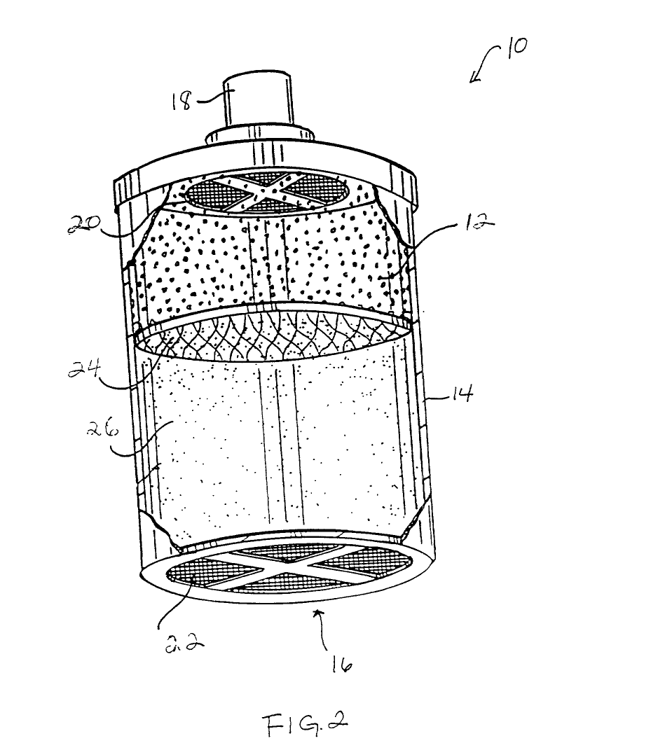

In another embodiment depicted in FIG. 2, a filter pad 24 seats between the inlet 16 and the outlet 18. The far infrared media 12 is located in between the filter pad 24 and the outlet screen 20. The filter pad 24 may be made of a polymeric material such as polypropylene having a mesh of from about 30 to about 200 microns, and in one embodiment about 100 microns. The filter pad 24 is useful in the removal of organic materials such as those associated with oils and oily emulsions. Other materials known in the art, which may be used to make the filter pad 24 include, stainless steel mesh, copper mesh, polyester pads, Teflon® (DuPont) pads, or molded plastic or nylon screen materials.

A copper media 26 may fill the region of the filter housing 14 between the filter pad 24 and the inlet screen 22 to enhance the effectiveness of the far infrared media 12. In one embodiment, the copper media 26 entirely fills this region and extends axially to at least about one-half of the axial length of the filter housing 12. The skilled artisan will appreciate that pad 24 need not be present to accomplish the objective of the present invention. In such an embodient, housing 14 is sequentially filled with media 12 and media 26 such that there are substantially distinct areas of media 12 and 26, yet they are in contact with each other.

In one embodiment, the copper media may be granular copper which may be substantially free of contaminants. The mesh of the granular copper media 26 may be about 120 mesh, although typical usage is from about 40 mesh to about 200 mesh. The density of the copper media 26 may range from about 3.5 to about 5 grams/cc, while the density of one embodiment is about 4.25 grams/cc. The copper media 26 is electrically conductive, and may range from a fine powder to very coarse spheres or pellets (e.g., 0.5-3 mm in diameter). Through the use of a bed or region of the copper media 26, the removal of undesirable contaminants such as chlorine, nitrates, iron, and hydrogen sulfide may be effected. The present invention works especially well in sulfated waters where sulfates have been used as sequestering or flocculating agents. Other contaminants in water, like lead and other heavy metals, are removed or reduced as the contaminant is bonded to the copper media 26. Further, it is believed that the copper oxidation/reduction reaction controls microbial growth. Organisms specifically controlled include fungi, algae and bacteria. Prior to use, the copper media 26 is processed, similar to an annealing process to remove oxides.

The amount of copper that may be used in the present invention is from about 10% to about 100% substantially pure copper with the preferred amount being 100%. In one embodiment, type 41 copper fills the region between the filter pad 24 and the inlet screen 22.

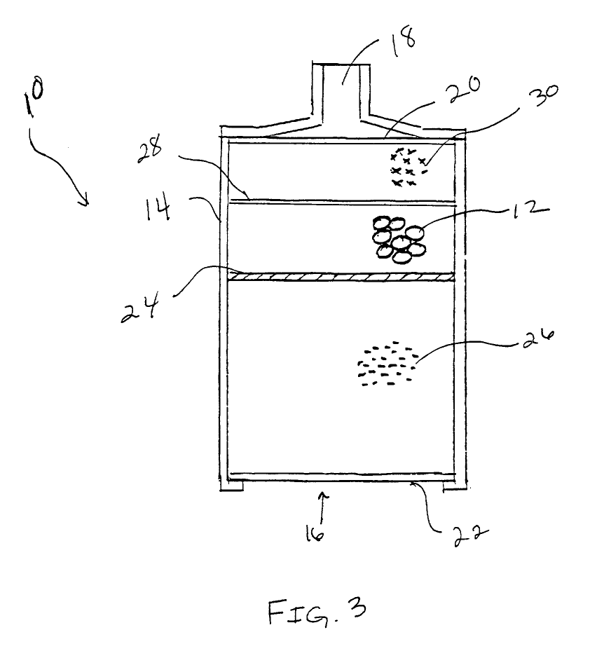

In another embodiment of the invention depicted in FIG. 3, a screen 28 seats between the filter pad 24 and the outlet screen 20 to separate the far infrared media 12 from a carbon media 30, although the same objectives may be attained without separation of the various media by a pad or screen if the media is filled into housing 14 sequentially. The carbon media 30 assists in the removal of organic contaminants from the water to be purified, such as radon. Such contaminants also include a broad range of bacterial species and other microorganisms. In one embodiment, the carbon media 30 is granulated activated carbon (GAC). The GAC has a mesh size of from about 10 mesh to about 100 mesh. GAC is characterized by a high adsorbitivity of gases, vapors and colloidal solids. Specifically, GAC is useful for reducing the radon content of the water to be purified. Further, GAC is used for taste and odor control.

The present invention therefore comprises a system capable of removing organic and inorganic contaminants regardless of form (liquid, solid or gas). Contaminants such as colloids and emulsions, as well as microbes, fungi and viruses, are also removed by the present system.

Various forms of filtration devices are known in the art and the foregoing description is not intended to limit the present invention to the embodiments disclosed as the media disclosed herein can be used in any filter devices. Further, other embodiments may utilize a shower filter as described in co-pending U.S. Patent Application Attorney Docket No. 09788980-0001 filed on Dec. 14, 2000, the disclosure of which is entirely incorporated by reference herein. Those skilled in the art can appreciate that other media, or combinations of media may be utilized in the present invention, including certain copper/zinc alloys, sodium sulfate and calcium sulfate.

Referring to FIG. 1, the present invention further comprises a method for removing contaminants from water comprising passing the water through the filter 10. First, the water passes through the inlet 16 and inlet screen 22 of the housing 14. Next, the water is dispersed through the far infrared media 12 within the housing 14 with the end result that the water becomes activated in a positive manner, probably by enhancing the redox potential. The contaminants are removed from the water by bonding the contaminants to the far infrared media 12. Also, organisms are removed from the water by reacting the organisms in an oxidation/reduction reaction with the far infrared media 12. The water, then, passes through the outlet screen 20 and outlet 18 of filter 10.

In another embodiment depicted in FIG. 2, after the water enters the filter through the inlet screen 22, the water is dispersed through the copper media 26 where organic contaminants are removed. The water then passes through the filter pad 24 secured within the housing 14. Next, the water is dispersed through the region of far infrared media 12. In one embodiment depicted in FIG. 3, the water travels from the far infrared media 12 through a screen 28 and is then dispersed through the carbon media 30 secured within the housing 14 where organic contaminants are further removed. The water is then exited out of the housing 13 through the outlet screen 20 and the outlet 18.

### EXAMPLE

A test was conducted to investigate the use of far infrared media 12 in shower filter cartridges to lower free chlorine levels in household water. There were eleven test cartridges used in the test series, the make-up of each cartridge is detailed in the test data. Cartridges numbered 1 and 2 were control cartridges manufactured to Waterpik and Paragon Water Systems, Inc. (“Paragon”) standards without the far infrared media 12.

The far-infrared media 12 was formed into ceramic beads composed of ceramic material and spherically shaped. The size of the ceramic beads ranged from about 0.170 to about 0.210 inches in diameter.

Eleven shower filter cartridges with the following blends or “make-ups” were made:

1. Standard Waterpik Cartridge- 10 oz. Type 41 Copper/Filter pad & Ring/2 oz. Carbon

2. Paragon Cartridge-8 oz. KDF/Disc/4 oz. KDF/Pad/0.7 oz. Carbon

3. 10 oz. Type 41 Copper mixed with 1 oz. Ceramic Beads/Filter pad & Ring/0.4 oz. Carbon

4. 10 oz. Type 61 Copper mixed with 1 oz. Ceramic Beads/Filter pad & Ring/1.2 oz. Carbon

5. 10 oz. Type 41 Copper/1 oz. Ceramic Beads/Filter pad & Ring/0.3 oz. Carbon

6. 10 oz. Type 41 Copper/Filter pad & Ring/1 oz. Ceramic Beads/0.3 oz. Carbon

7. 10 oz. Type 61 Copper/1 oz. Ceramic Beads/Filter pad & Ring/1.3 oz. Carbon

8. 10 oz. Type 61 Copper/Filter pad & Ring/1 oz. Ceramic Beads/1.3 oz. Carbon

9. 8 oz. KDF/Disc/4 oz. KDF mixed with 1 oz. Ceramic Beads/Filter pad/0.5 oz. Carbon

10. 12 oz. KDF/Disc/1 oz. Ceramic Beads/Filter pad/0.2 oz. Carbon

11. 12 oz. KDF/Disc/1 oz. Ceramic Beads/0.5 oz. Carbon

Test Procedure:

The test shower cartridges were installed in a standard shower filter unit and set-up in a test stand. The test water was Pinellas County Florida water with a chlorine content as measured during the test; the chlorine content ranged from 0.94 to 1.05 ppm during the test. Water flow through the test sample was approximately 2.5 gpm. The test measurement apparatus was a Hach Pocket Colorimeter, model 46700-12, using Hack DPD Free Chlorine Reagents.

Test Results

Test results were tabulated using the numeration above.

| | | 2 Minute | 15 Minute |
|---|---|---|---|
| Test | Input Chlorine | Reading | Reading |
| sample | Content-ppm | Reduction % | Reduction % |
| 1 | 1.00 | 0.00/100 | 0.07/93 |
| 2 | 1.00 | 0.07/93 | 0.04/94 |
| 3 | 0.98 | 0.05/97 | 0.05/97 |
| 4 | 0.98 | 0.14/86 | 0.11/89 |
| 5 | 0.94 | 0.06/83 | 0.13/86 |
| 6 | 0.94 | 0.01/99 | 0.01/99 |
| 7 | 1.00 | 0.17/83 | 0.19/81 |
| 8 | 0.99 | 0.06/94 | 0.04/96 |
| 9 | 0.99/1.05 | 0.21/79 | 0.15/86* |
| 10 | 0.99/1.05 | 0.19/81 | 0.16/85 |
| 11 | 1.05 | 0.08/92 | 0.09/91 |

*Based on Input Chlorine Content of 1.05 ppm.

Conclusion

The results above were compared. It was found that samples employing far infrared media with type 41 copper had improved chlorine reduction capability over other samples.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the claims appended herewith.

I claim:

1. A filtration device, comprising:
a housing having an inlet and an outlet; and
a far infrared media disposed within the housing.

2. The device of claim 1, wherein the far infrared media comprises at least about 20% of silica, about 15% of aluminum, about 10% of potassium, and about 5% of iron.

3. The device of claim 1, wherein the far infrared media comprises ceramic beads.

4. The device of claim 3, wherein the ceramic beads have a diameter from about 0.01 to about 2.0 inches.

5. The device of claim 1, further comprising at least one screen configured to retain the far infrared media within the housing.

6. The device of claim 5, wherein the at least one screen comprises an inlet screen and an outlet screen.

7. The device of claim 6, wherein the far infrared media extends from the inlet screen to the outlet screen.

8. A filtration device, comprising:
(a) a housing having an inlet and an outlet;
(b) a far infrared media disposed within the housing;
(c) a copper media disposed within the housing;
(d) at least one screen configured to retain the far infrared media and the copper media within the housing; and
(e) a filter pad secured within the filter housing, the filter pad configured to separate the far-infrared media from the copper media.

9. The device of claim 8, wherein the far infrared media comprises at least about 20% of silica, about 15% of aluminum, about 10% of potassium, and about 5% of iron.

10. The device of claim 8, wherein the copper media comprises type 41 copper.

11. The device of claim 8, wherein the copper media comprises a mesh size of from about 40 micron to about 200 micron.

12. The device of claim 8, wherein the copper media comprises a density of from about 3.5 grams/cc to about 5 grams/cc.

13. The device of claim 8, wherein the at least one screen comprises an inlet screen and an outlet screen.

14. The device of claim 13, wherein the filter pad seats between the inlet I-S screen and the outlet screen.

15. The device of claim 8, wherein the filter pad has a mesh of from about 30 microns to about 200 microns.

16. The device of claim 13, further comprising a carbon media positioned between the outlet screen and the far infrared media.

17. The device of claim 16, wherein at least one screen separates the carbon media from the far infrared media.

18. The device of claim 16, wherein the carbon media comprises granulated activated carbon.

19. The device of claim 18, wherein the granulated activated carbon has a mesh size of from about 10 mesh to about 100 mesh.

20. The device of claim 8, wherein the filter pad comprises a polymeric pad.

21. The device of claim 8, wherein the filter pad comprises a polypropylene pad.

22. The device of claim 8, wherein the at least one screen comprises a stainless steel screen.

23. A method for purifying water, comprising:
(a) passing the water into a filter comprising a housing and a far-infrared media;
(b) dispersing the water through the far-infrared media disposed within the housing;
(c) removing contaminants from the water by bonding the contaminants to the far-infrared media; and
(d) exiting the water out of the housing.

24. The method of claim 23, further comprising dispersing the water through a copper media disposed within the housing after passing the water into the filter.

25. The method of claim 24, further comprising passing the water through a filter pad secured within the housing after dispersing the water through the copper media.

26. The method of claim 23, further comprising passing the water through a screen secured within the housing after dispersing the water through the far-infrared media.

27. The method of claim 26, further comprising dispersing the water through a carbon media disposed within the housing after passing the water through the screen.

28. The method of claim 23, further comprising killing organisms in the water by reacting the organisms in an oxidation/reduction reaction with the far-infrared media.

29. The method of claim 24, further comprising removing contaminants from the water by bonding the contaminants to the copper media.

30. The method of claim 27, further comprising removing contaminants from the water by bonding the contaminants to the carbon media.
